(19) United States
(12) Patent Application Publication
(10) Pub. No.: US 2002/0146502 A1
(43) Pub. Date: Oct. 10, 2002

(54) Sorbic acid as growth-stabilizing addition to feedstuffs for agricultural livestock rearing

(76) Inventor: Nico N. Raczek, Kelkheim (DE)

Correspondence Address: PROPAT, L.L.C., 2912 CROSBY ROAD, CHARLOTTE, NC, 28211-2815, US

(21) Appl. No.: 10/057,212

(22) Filed: Jan. 24, 2002

(30) Foreign Application Priority Data
Feb. 2, 2001 (DE) 101 05 308.8

(51) Int. Cl. A01K 1/00

(52) U.S. Cl. 426/654

(57) ABSTRACT

The present invention relates to a method using sorbic acid, preferably in a concentration of >0 to <1.2% by weight (based on the feedstuff), with a growth-stabilizing effect. The feedstuff can be employed for improving performance in agricultural livestock rearing.

### BACKGROUND OF THE INVENTION

The invention relates to the use of sorbic acid as growth-stabilizing addition to feedstuffs preferably in concentrations of from >0 to <1.2% by weight (based on the feedstuff).

Antibiotics are frequently used to improve performance in the animal feed sector. The use of antibiotics in this sector is suspected of being responsible for the dangers derived from resistant bacteria, which may also endanger human health in the long term. It is therefore necessary to look for products about which there are fewer health doubts for this purpose of use. Thus, in other sectors too there is increasing replacement of substances about which there are physiological and epidemiological health doubts or else which are harmful for the environment, such as, for example, antibiotics, formaldehyde-emitting materials, halogenated substances and many others by materials about which there are fewer doubts, for example in human foods, feedstuffs, domestic animal feed, silages, pomace or other waste material from the food industry. The purpose of these materials is, on the one hand, aimed at maintaining the value of the actual product. However, on the other hand, it is also intended to improve the hygienic condition thereof and achieve a longer shelf life.

It is known that sorbic acid can be employed for preserving feedstuffs. Sorbic acid (trans,trans-2,4-hexadienoic acid) is a colorless solid compound which dissolves only slightly in cold water and is used around the world as preservative. The principle of action is determined by sorbic acid in undissociated form. Sorbic acid therefore displays its best effect in the acidic pH range. Sorbic acid and its salts have a very good microbiostatic, antimycotic action. At the same time, as unsaturated fatty acid, sorbic acid is virtually nontoxic, which is proven by very extensive data and by the decades of use of this acid in the human food sector, in animal feeds inter alia.

Feeding trials have been previously been carried out in particular with piglets, which demonstrated that various organic acids such as citric acid, fumaric acid or formic acid are able to have a beneficial effect on animal performance if they are mixed in optimal dosage with the piglet feed (Zbl. Hyg. 191, 265-276, Kirchgessner and Roth, 1991; Journal of Animal and Feed Sciences, 7, 1998, 25-33, Roth and Kirchgessner). However, these acids have corrosive effects and, because of their volatility, in some cases cause an odor nuisance and require special care in handling if the risk of intake by inhalation, which is undesirable from the health and safety viewpoint, is to be avoided.

It has also very recently been possible to show that sorbic acid in high concentrations (1.2-2.4% sorbic acid based on the feedstuff) has nutritional activity for rearing piglets (J. Anim. Physiol. a. Anim. Nutr. 74 (1995), 235-242, Kirchgessner et al.). At the 6th Pig and Poultry Nutrition Meeting (meeting proceedings, p. 60, 61, J. Rühle et al., ‘Zur Wirkung von Ameisen-, Milch- und Sorbinsäure auf einige Leistungs- und Stoffwechselkenndaten beim Absetzferkel’) the effect inter alia of sorbic acid for improving performance in piglet rearing was reported. Compared with formic and lactic acids, the best growth-promoting effect was achieved with sorbic acid. The concentration of sorbic acid per kg of feedstuff in these investigations was 0.185 mol/kg (about 2.1% by weight). In Kraftfutter/Feed Magazine February 1999, pp. 49ff (M. Freitag et al.), sorbic acid is described as performance-improving addition to the feed stuff ‘in the medium concentration range’; concentration ranges from 1.2 to 2.4% by weight in the feedstuff are known (see, for example, J. Anim. Physiol. a. Anim. Nutr. 74 (1995), 235 - 242, Kirchgessner et al.).

WO 00/36928 describes performance-improving additions to feedstuffs which contain C₆-C₁₀ carboxylic acids or carboxylic acid salts. The additions are present in the feedstuff in amounts of 10-30% by weight. Unsaturated or even polyunsaturated carboxylic acids are not described therein, above all no sorbic acid.

As aliphatic unsaturated carboxylic acid, sorbic acid shows remarkably high storage stability and scarcely attacks metals and, in practical applications, causes scarcely any odor nuisance so that sorbic acid has advantageous physicochemical properties for processing in the stated range. This is additionally associated with good handling properties. Sorbic acid is therefore an ideal additive to feedstuffs. However, it is still a disadvantage that the use of sorbic acid—especially in the light of the high concentrations—is not economic. There has been a continuing need for a low-cost feedstuff with growth-stabilizing additions without the disadvantages of the materials normally used at present.

It has been found, surprisingly, that a marked and particularly economic improvement in growth in terms of growth rate and feed conversion can be achieved through the addition of smaller amounts of sorbic acid than generally assumed to date in agricultural livestock rearing especially piglet rearing. This emerges even with additions of from >0 to <1.2% by weight, based on the feed, in particular 0.5-1.0% by weight, preferably 0.625-0.875% by weight.

### BRIEF DESCRIPTION OF THE INVENTION

The invention accordingly relates to the method of using sorbic acid as growth-stabilizing addition to feedstuffs, in particular in concentrations of from >0 to <1.2% by weight (based on the feedstuff). The invention further relates to a feedstuff for achieving a growth-stabilizing effect which comprises sorbic acid preferably in a concentration of from >0 to <1.2% (based on the feedstuff), and to sorbic acid-containing products for producing feedstuffs.

### DETAILED DESCRIPTION OF THE INVENTION

Examples of suitable animal feedstuffs are green fodder, silages, dried green fodder, roots, tubers, fleshy fruits, grains and seeds, brewer's grains, pomace, brewer's yeast, distillation residues, milling byproducts, byproducts of the production of sugar and starch and oil production and various food wastes. Feedstuffs of these types may be mixed with certain feedstuff additives (e.g. antioxidants) or mixtures of various substances (e.g. mineral mixes, vitamin mixes) for improvement. Specific feedstuffs are also adapted for particular species and their stage of development. This is the case, for example, in piglet rearing. Prestarter and starter feeds are used here. Feedstuffs having the addition according to the invention of sorbic acid are moreover suitable as milk replacers for the early weaning of lambs or calves.

Sorbic acid can be added directly to the animal feedstuff, individual components thereof or other added substances such as feedstuff additives or else via premixes of various components to the actual feedstuff. These include inter alia mineral mixes, acid mixes and vitamin mixes, flavoring products, supplementary feedstuffs, mixtures thereof and mixtures of such products with components of the feedstuffs. They can be admixed with the feedstuffs, individual components thereof or dry with the feed, be added before further processing (e.g. extrusion) or be mixed in and dispersed in the mixture. If ascorbic acid is added via individual components of the feedstuff or premixes, the dosages are chosen so that they result in the contents according to the invention in the feedstuff.

Sorbic acid exists in solid form. It can be incorporated without difficulty into solid and pasty feedstuffs. Since the solubility limit is exceeded in feedstuffs which contain water and are only slightly acidic, it is expedient to employ sorbic acid of small particle size, in which case at least 80% by weight should be in the range below 555 μm, preferably even below 355 μm, in order to achieve distribution which is as uniform as possible.

The invention is illustrated below by means of examples.

### EXAMPLE 1

In order to investigate the growth-stabilizing activity of sorbic acid in the concentration range according to the invention, feeding trials were carried out with groups of 48 weaners each housed singly. The feed in the four trial groups had an isoenergetic composition and was provided to the animals ad libitum. In this trial, the activity of sorbic acid in the low dose range was tested on piglets. For this purpose, 0 (no addition); 0.1; 0.55 and 1% by weight sorbic acid were added to the feed. The results of this trial are summarized in table 1. Addition of sorbic acid to the feed had a marked effect on the stock. In particular, the sorbic acid levels of 0.55 and 1% increased the growth rates starting from 491 g/day by 7% and 16% respectively (P<0.05). At the same time, the stock consumed 7% and 14%, respectively, more feed because of the addition of sorbic acid.

TABLE I
Live weights, daily gains, feed consumption and feed conversion
of rearing piglets on addition of sorbic acid to the feed

| Addition calculated as % by | | | | |
|---|---|---|---|---|
| weight sorbic acid based on the | | | | |
| total feed; day 0-41 | - | 0.1 | 0.55 | 1 |
| Initial weight, kg | 7.60 ± | 7.60 ± | 7.60 ± | 7.60 ± |
| | 0.82 | 0.98 | 1.04 | 0.94 |
| Final weight, kg | 27.72^{ab} ± | 26.69^{b} ± | 29.16^{ab} ± | 30.96^{a} ± |
| | 3.04 | 3.00 | 3.48 | 3.35 |
| relative | 100 | 96.3 | 105.2 | 111.7 |
| Growth rate, g/d | 491^{b} ± | 466^{b} ± | 526^{ab} ± | 570^{a} ± |
| | 72 | 65 | 65 | 73 |
| relative | 100 | 94.5 | 107.1 | 116.1 |
| Feed consumption, g/d | 678^{ab} ± | 640^{b} ± | 729^{ab} ± | 775^{a} ± |
| | 102 | 96 | 102 | 93 |
| relative | 100 | 94.4 | 107.5 | 114.3 |
| Feed conversion | 1.38 ± | 1.38 ± | 1.38 ± | 1.36 ± |
| (g feed/g gained) | 0.04 | 0.08 | 0.06 | 0.08 |
| relative | 100 | 100 | 100 | 98.5 |

^{a,b}Significantly different means (p < 0.05)

Comparison of the results of trials of identical design surprisingly reveals in addition that there is no linear dependence in the growth rates and feed conversion of the stock in particular on addition of sorbic acid to piglet feed (prestarter); the relative gains in the literature (J. Anim. Physiol. a. Anim. Nutr. 74 (1995), 235-242, Kirchgessner et al.: ‘Zur nutritiven Wirkung von Sorbinsäure in der Ferkelaufzucht’) on supplementation of feed with sorbic acid are shown in parentheses for use concentrations of 1.2 (109%), 1.8 (117%) and 2.4% (123%). By contrast, on use of sorbic acid in the concentrations according to the invention, considerably higher growth rates are achieved as shown in parentheses on addition of 0.55 (115%) and 1.0% (128%) sorbic acid.

In addition, on use of sorbic acid in the concentrations according to the invention, the feed conversion by the stock—compared with higher concentration ranges—is remarkably better.

1. The method of using sorbic acid as growth-stabilizing addition to feedstuffs, which method comprises adding sorbic acid to feedstuffs.

2. The method as claimed in claim 1, wherein the sorbic acid is employed in concentrations of from >0 to <1.2% by weight (based on the feedstuff).

3. The method as claimed in claim 1, wherein the concentration of sorbic acid is in the range from 0.5 to 1.0% by weight (based on the feedstuff).

4. The method as claimed in claim 1 in pig rearing.

5. The method as claimed in claim 1 in cattle rearing.

6. The method as claimed in claim 1 in lamb rearing.

7. The method as claimed in claim 1 in poultry rearing.

8. The method as claimed in claim 1 in rabbit rearing.
